(19) United States
(12) Patent Application Publication
(10) Pub. No.: US 2026/0095118 A1
(43) Pub. Date: Apr. 2, 2026

(54) METHOD AND APPARATUS FOR EXTRACTING PARAMETERS OF INDUCTION MOTOR

(71) Applicants: HYUNDAI MOTOR COMPANY, SEOUL (KR); KIA CORPORATION, SEOUL (KR); MYONGJI UNIVERSITY INDUSTRY AND ACADEMIA COOPERATION FOUNDATION, YONGIN-SI (KR); KOREA UNIVERSITY RESEARCH AND BUSINESS FOUNDATION, SEOUL (KR)

(72) Inventors: Jung Hwi Kim, Hwaseong-si (KR); Hong Geuk Park, Hwaseong-si (KR); Tae Young Chung, Hwaseong-si (KR); Jae Hak Kim, Hwaseong-si (KR); Yongsu Han, Yongin-si (KR); Hyeon-Seong Kim, Seoul (KR); Kibok Lee, Seoul (KR)

(73) Assignees: HYUNDAI MOTOR COMPANY, SEOUL (KR); KIA CORPORATION, SEOUL (KR); MYONGJI UNIVERSITY INDUSTRY AND ACADEMIA COOPERATION FOUNDATION, YONGIN-SI (KR); KOREA UNIVERSITY RESEARCH AND BUSINESS FOUNDATION, SEOUL (KR)

(21) Appl. No.: 19/248,850

(22) Filed: Jun. 25, 2025

(30) Foreign Application Priority Data
Sep. 27, 2024 (KR) 10-2024-0131997

(51) Int. Cl. H02P 23/14; H02P 27/06

(52) U.S. Cl. CPC H02P 23/14; H02P 27/06

(57) ABSTRACT

A method for extracting parameters of an induction motor includes driving the induction motor by controlling an inverter based on current commands, measuring torque of the induction motor and reactive power of the inverter according to the driving of the induction motor, estimating stator flux values of the induction motor based on the measured torque and reactive power, and extracting the parameters of the induction motor based on the stator flux values.

### CROSS REFERENCE TO RELATED APPLICATIONS

The present application claims priority to Korean Patent Application No. 10-2024-0131997, filed Sep. 27, 2024, the entire contents of which are incorporated herein for all purposes by this reference.

### BACKGROUND

### Field

The present disclosure relates to a method and an apparatus thereof for extracting parameters of an induction motor based on torque and reactive power thereof.

### Description of the Related Art

An induction motor is a device for generating rotational force through the electromagnetic force of induced current, and to this end, the induction motor includes a stator for forming a rotating magnetic field and a rotor for generating the rotational force through the electromagnetic force of the induced current generated by the rotating magnetic field.

Instantaneous torque control of such induction motors may be performed through a direct torque control (DTC) method, and to this end, there is required accurate estimation of magnetic flux angles and extraction of a current command map optimized for each of the induction motors.

Various parameters of an induction motor are used to estimate magnetic flux angles for each induction motor, and the precision of torque control during direct torque control may vary depending on the accuracy of the parameters. In addition, in order to perform electric current control of the induction motor, magnetic flux and torque are required for each operating point, and in this case, when an error occurs in a magnetic flux value, it may affect the precision and efficiency of torque control in a weak magnetic flux region.

Accordingly, in order to improve the driving performance of an induction motor, there is required to propose a method capable of improving the accuracy and precision of parameter extraction in order to control the induction motor.

The foregoing is intended merely to aid in the understanding of the background of the present disclosure, and is not intended to mean that the present disclosure falls within the purview of the related art that is already known to those skilled in the art.

### SUMMARY

An objective of the present disclosure is to provide a method and an apparatus thereof for extracting parameters of an induction motor, wherein the accuracy of parameter extraction may be improved by extracting the parameters of the induction motor based on magnetic flux values estimated based on torque and reactive power thereof.

The problems of the present disclosure are not limited to the above-mentioned problems, and other problems not described above will be clearly understood by those skilled in the art from the description of the claims.

According to an exemplary embodiment of the present disclosure to solve the above-mentioned problems, there is provided a method of extracting parameters of an induction motor, the method including driving the induction motor by controlling an inverter based on current commands, measuring torque of the induction motor and reactive power of the inverter according to the driving of the induction motor, estimating stator flux values of the induction motor based on the measured torque and reactive power, and extracting the parameters of the induction motor based on the stator flux values.

For example, the parameters of the induction motor may include at least one of a rotor time constant, rotor flux values, stator inductance, and a leakage constant.

For example, the method may further include estimating a rotor flux angle error of the induction motor based on the estimated stator flux values, wherein the extracting of the parameters of the induction motor may include extracting the parameters of the induction motor based on the estimated rotor flux angle error.

For example, the method may further include correcting the current commands based on the estimated rotor flux angle error, wherein the driving of the induction motor may include driving the induction motor by controlling the inverter based on the corrected current commands.

For example, the correcting of the current commands may include repeating the correction of the current commands until the rotor flux angle error becomes a value less than or equal to a preset value, and the extracting of the parameters may include extracting the parameters when the rotor flux angle error becomes the value less than or equal to the preset value.

For example, the driving of the induction motor may include driving the induction motor by controlling the inverter based on the respective current commands corresponding to a plurality of operating points, the measuring of the torque of the induction motor and the reactive power of the inverter may include measuring the torque and the reactive power for each of the plurality of operating points, and the estimating of the stator flux values of the induction motor may include estimating the stator flux values corresponding to the torque and the reactive power, which are measured for each of the plurality of operating points.

For example, the respective current commands corresponding to the plurality of operating points may be determined based on a preset current command map, and the correcting of the current commands may include correcting the current command map based on the rotor flux angle error.

For example, the extracting of the parameters may include extracting the parameters corresponding to the respective current commands comprised in the corrected current command map.

For example, the driving of the induction motor may include initially driving the induction motor by controlling the inverter based on initial parameters of the induction motor, the initial parameters being obtained under preset driving conditions comprising a constraint condition and a no-load condition, and the measuring of the torque of the induction motor and the reactive power of the inverter may include measuring the torque of the induction motor and the reactive power of the inverter according to the initial driving of the induction motor.

According to an exemplary embodiment of the present disclosure to solve the above-mentioned problems, there is provided an apparatus of extracting parameters of an induction motor, the apparatus including: a drive unit for driving the induction motor by controlling an inverter based on current commands; a measurement unit for measuring torque of the induction motor and reactive power of the inverter according to the driving of the induction motor; an estimation unit for estimating stator flux values of the induction motor based on the measured torque and reactive power; and an extraction unit for extracting the parameters of the induction motor based on the stator flux values.

For example, the parameters of the induction motor may include at least one of a rotor time constant, rotor flux values, stator inductance, and a leakage constant.

For example, the estimation unit may estimate a rotor flux angle error of the induction motor based on the estimated stator flux values, and the extraction unit may extract the parameters of the induction motor based on the estimated rotor flux angle error.

For example, the apparatus may further include a correction unit for correcting the current commands based on the estimated rotor flux angle error, wherein the drive unit may drive the induction motor by controlling the inverter based on the corrected current commands.

For example, the correction unit may repeat the correction of the current commands until the rotor flux angle error becomes a value less than or equal to a preset value, and the extraction unit may extract the parameters when the rotor flux angle error becomes the value less than or equal to the preset value.

For example, the drive unit may drive the induction motor by controlling the inverter based on the respective current commands corresponding to a plurality of operating points, the measurement unit may measure the torque and the reactive power for each of the plurality of operating points, and the estimation unit may estimate the stator flux values corresponding to the torque and the reactive power, which are measured for each of the plurality of operating points.

For example, the respective current commands corresponding to the plurality of operating points may be determined based on a preset current command map, and the correction unit may correct the current command map based on the rotor flux angle error.

For example, the extraction unit may extract the parameters corresponding to the respective current commands comprised in the corrected current command map.

For example, the drive unit initially may drive the induction motor by controlling the inverter based on initial parameters of the induction motor, the initial parameters being obtained under preset driving conditions comprising a constraint condition and a no-load condition, and the measurement unit may measure the torque of the induction motor and the reactive power of the inverter according to the initial driving of the induction motor.

According to various exemplary embodiments of the present disclosure as described above, the accuracy of parameter extraction of an induction motor may be improved by utilizing magnetic flux values estimated based on the measured values of torque and reactive power.

The effects of the present disclosure are not limited to the above-mentioned effects, and other effects that are not mentioned will be clearly understood by those skilled in the art from the following description.

### BRIEF DESCRIPTION OF THE FIGURES

FIG. 1 is a view illustrating a configuration of an apparatus for extracting parameters of an induction motor according to an exemplary embodiment of the present disclosure.

FIG. 2 is a view illustrating an equivalent circuit of the induction motor applicable to exemplary embodiments of the present disclosure.

FIG. 3 is a flowchart for describing a process of extracting parameters of an induction motor according to an exemplary embodiment of the present disclosure.

### DETAILED DESCRIPTION

Specific structural and functional descriptions of the embodiments of the present disclosure disclosed herein are only for illustrative purposes of the embodiments of the present disclosure. The present disclosure may be embodied in various forms, and should not be construed as limited to the embodiments described in the present specification or application.

Since the exemplary embodiments of the present disclosure may be variously modified in many different forms, specific exemplary embodiments will be illustrated in the drawings and described in detail in the specification or application of the present disclosure. However, this is not intended to limit the exemplary embodiments in accordance with the concept of the present disclosure to a particular disclosed form. On the contrary, the present disclosure is to be understood to include all various alternatives, equivalents, and substitutes that may be included within the spirit and scope of the present disclosure.

Unless otherwise defined, all terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the related art, and will not be interpreted in an idealized or overly formal sense unless expressly so defined herein.

Hereinafter, the exemplary embodiments disclosed in the present specification will be described in detail with reference to the accompanying drawings, but regardless of the reference numerals, the same or similar components are given the same reference numbers, and the overlapping description thereof will be omitted.

In the description of the following exemplary embodiments, the term “preset” means that a value of a parameter is predetermined when the parameter is used in process or algorithm. Depending on the exemplary embodiments, a numerical value of the parameter may be set when the process or algorithm starts execution or may be set during a section in which the process or algorithm is performed.

The words “module” and “part/unit” used as words for the components used in the following descriptions are given or mixed in consideration of only the case of writing the specification, and the noun suffixes do not have distinct meanings or roles by themselves.

In describing the exemplary embodiments disclosed in the present specification, when it is determined that a detailed description of a related known technology may obscure the subject matter of the exemplary embodiments disclosed in the present specification, the detailed description thereof will be omitted. In addition, the accompanying drawings are only for easy understanding of the exemplary embodiments disclosed in the present specification, the technical idea disclosed in the present specification is not limited by the accompanying drawings, and it should be understood that the accompanying drawings include all changes, equivalents, or substitutes, which are included in the spirit and technical scope of the present disclosure.

It will be understood that, although the terms including ordinal numbers, such as first, second, etc. may be used herein to describe various components, these components should not be limited by these terms. These terms are only used for the purpose of distinguishing one component from another component.

It will be understood that when a component is referred to as being “coupled”, “connected”, or “linked” to another component, it may be directly coupled or connected to the other component or intervening components may be present. In contrast, when a component is described as being “directly connected”, “directly coupled”, or “directly linked” to another component, it should be understood that there are no intervening component present therebetween.

As used herein, the singular forms are intended to include the plural forms as well, unless the context clearly indicates otherwise.

It will be further understood that the terms “comprise”, “include”, “have”, and the like when used in the present specification, specify the presence of stated features, integers, steps, operations, components, parts, and/or combinations of them but do not preclude the presence or addition of one or more other features, integers, steps, operations, components, parts, and/or combinations thereof.

In addition, a unit or control unit included in names such as a motor control unit (MCU) and a hybrid control unit (HCU) is just a term widely used for naming of a controller that controls vehicle-specific functions, and does not mean a generic function unit.

Proposed are a method and an apparatus thereof for extracting parameters of an induction motor according to the exemplary embodiments of the present disclosure, wherein magnetic flux values of the induction motor are estimated based on measured values of torque and reactive power, and through this way, the parameters of the induction motor are extracted, so as to improve the accuracy of parameter extraction. According to the parameters with the accuracy improved in this way, the performances of magnetic flux angle estimation and current control in the induction motor is improved, whereby the precision and efficiency of torque control may be improved.

In this case, the parameters of the induction motor may include at least one of the rotor time constant, rotor flux value, stator inductance, and leakage constant thereof, and may include all the parameters depending on exemplary embodiments. However, the induction motor's parameters extractable depending on the exemplary embodiments are not necessarily limited to those described above.

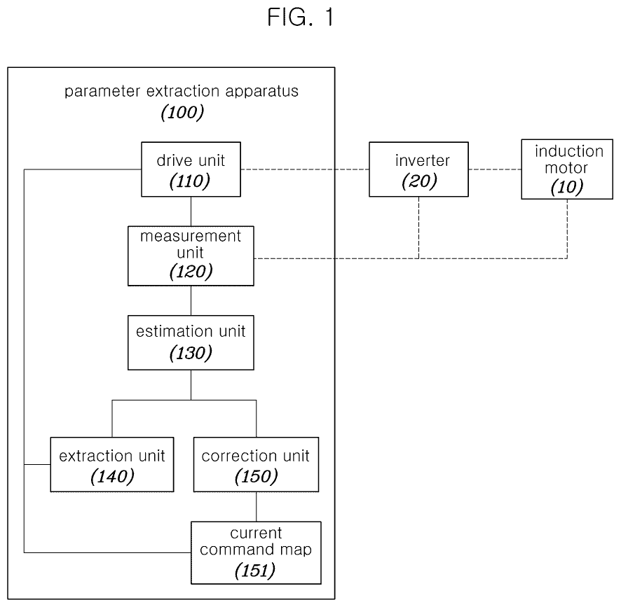

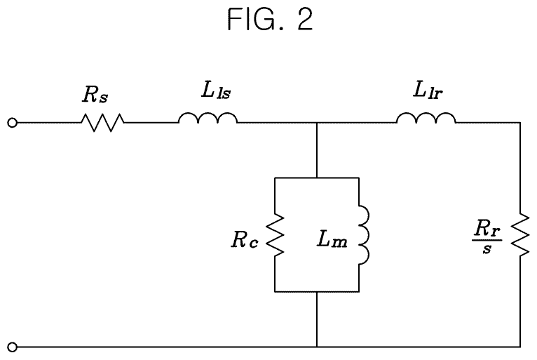

Hereinafter, an apparatus for extracting parameters of an induction motor according to the exemplary embodiments of the present disclosure will first be described with reference to FIGS. 1 and 2 before describing the method for extracting the parameters of the induction motor according to the exemplary embodiments of the present disclosure.

FIG. 1 is a view illustrating a configuration of an apparatus for extracting parameters of an induction motor according to an exemplary embodiment of the present disclosure. FIG. 2 is a view illustrating an equivalent circuit of the induction motor applicable to exemplary embodiments of the present disclosure.

Referring to FIG. 1, a parameter extraction apparatus 100 according to the exemplary embodiments of the present disclosure may include a drive unit 110, a measurement unit 120, an estimation unit 130, an extraction unit 140, a correction unit 150, and a current command map 151.

However, FIG. 1 mainly illustrates components related to the description of the exemplary embodiments of the present disclosure, and it is natural that the parameter extraction apparatus 100 may actually be implemented with more or fewer components than the components.

In addition, the parameter extraction apparatus 100 may be implemented with a controller for controlling the driving of an induction motor 10 through an inverter 20, and for such implementation, it may include: a communication device for communicating with other controllers or sensors; a memory for storing an operating system, logic instructions, input/output information, etc.; and one or more processors for performing determinations, calculations, and decisions, which are required for controlling the functions in charge.

For example, the parameter extraction apparatus 100 may be implemented by using motor controllers. Each of a drive unit 110 and a measurement unit 120 may be implemented with a motor controller and the remaining components may be implemented with separate controllers connected to the motor controllers. Hereinafter, each component is described in detail.

First, the drive unit 110 may drive the induction motor 10 by controlling the inverter 20. To this end, the drive unit 110 may apply phase voltage to stator windings of the induction motor 10 by performing pulse width modulation (PWM) control and the like based on current commands.

The drive unit 110 may initially drive the induction motor 10 by controlling the inverter 20 based on initial parameters of the induction motor 10, the initial parameters being obtained under preset driving conditions including a constraint condition and a no-load condition.

Here, the initial driving may mean the driving of the induction motor 10 at a time when the parameter extraction apparatus 100 according to the exemplary embodiments of the present disclosure is initially driven, and the initial parameters may mean parameters extracted separately for the initial driving of the induction motor 10 before the parameters are extracted by the parameter extraction apparatus 100.

More specifically, the constraint condition may mean a state where slip s has a value of 1 or a value close to 1, and in this case, iron loss resistance Rc and magnetizing inductance Lm may be ignored in the equivalent circuit shown in FIG. 2. Under such a constraint, rotor resistance Rr, stator leakage inductance Lls, and rotor leakage inductance Llr may be obtained as initial parameters.

In addition, the no-load condition may mean a state where slip s has a value of 0 or a value close to 0, and in this case, the rotor leakage inductance Llr and the rotor resistance Rr may be ignored in the equivalent circuit shown in FIG. 2. Under such a no-load condition, the iron loss resistance Rc and stator inductance (i.e., Lls+Lm) may be obtained as initial parameters.

In addition, the stator resistance Rs may be obtained by measuring resistance values between windings of the induction motor of which the windings are in a state of being connected to each other, and the drive unit 110 initially drives the induction motor 10 through such initial parameters.

After the initial driving, the induction motor 10 may be driven through the updated parameters by utilizing a stator flux value estimated according to torque and reactive power.

The measurement unit 120 may measure torque of the induction motor 10 and reactive power of the inverter 20, which are generated by driving the induction motor 10. To this end, the measurement unit 120 may include a torque sensor connected to the induction motor 10 and measuring torque output by the induction motor 10, and a voltage sensor and a current sensor, which are connected to the inverter 20 to measure voltage, current, etc. of the inverter 20, or may obtain measurement results from these sensors.

Meanwhile, the measured torque and reactive power may be expressed by Equation 1 below.

$$[ \begin{matrix}{T}_{e} \\ {Q}_{s}\end{matrix} ] = \frac{3}{2} [ \begin{matrix}pp \cdot {{i}_{qs}^{e}}^{*} & - pp \cdot {{i}_{ds}^{e}}^{*} \\ {ω}_{e} {{i}_{qs}^{e}}^{*} & {ω}_{e} {{i}_{ds}^{e}}^{*}\end{matrix} ] [ \begin{matrix}{λ}_{ds}^{\hat{e}} \\ {λ}_{qs}^{\hat{e}}\end{matrix} ] \qquad Equation 1$$

Here, Tₑ represents torque, Qₛ represents reactive power, pp represents the number of pole pairs of a rotor,

$${{i}_{qs}^{e}}^{*} and {{i}_{qs}^{e}}^{*}$$

represent respective current commands of a d-axis and q-axis of a synchronous coordinate system, ωₑ represents synchronous speed, and

$${λ}_{ds}^{\hat{e}} and {λ}_{qs}^{\hat{e}}$$

represent respective stator flux values of the d-axis and q-axis of the synchronous coordinate system.

The estimation unit 130 may estimate the stator flux values of the induction motor 10 based on the torque and reactive power measured by the measurement unit 120. More specifically, the stator flux values may be estimated by relationships between the torque, reactive power, and stator flux values, which are shown in the following Equation 2 that is derivable from Equation 1.

$$[ \begin{matrix}{λ}_{ds}^{\hat{e}} \\ {λ}_{qs}^{\hat{e}}\end{matrix} ] = {\frac{2}{3} [ \begin{matrix}pp \cdot {{i}_{qs}^{e}}^{*} & - pp \cdot {{i}_{ds}^{e}}^{*} \\ {ω}_{e} {{i}_{qs}^{e}}^{*} & {ω}_{e} {{i}_{ds}^{e}}^{*}\end{matrix} ]}^{- 1} [ \begin{matrix}{T}_{e} \\ {Q}_{s}\end{matrix} ] \qquad Equation 2$$

That is, in the exemplary embodiments, the estimation unit 130 may estimate the stator flux values inversely from the measured torque and reactive power by utilizing the relationships between the torque, the reactive power, and the stator flux values, thereby improving the accuracy of magnetic flux value estimation.

Furthermore, the estimation unit 130 may estimate a rotor flux angle error of the induction motor 10 based on the stator flux values estimated as above. More specifically, the estimation unit 130 may estimate rotor flux values based on the stator flux values estimated by utilizing Equation 3 through Equation 6 below.

$${λ}_{dr}^{\hat{e}} = \frac{{L}_{r}}{{L}_{m} ( {λ}_{ds}^{\hat{e}} - σ {L}_{s} {{i}_{ds}^{e}}^{*} )} \qquad Equation 3$$

$${λ}_{qr}^{\hat{e}} = \frac{{L}_{r}}{{L}_{m} ( {λ}_{qs}^{\hat{e}} - σ {L}_{s} {{i}_{qs}^{e}}^{*} )} \qquad Equation 4$$

$${L}_{s} = \frac{{λ}_{ds}^{\hat{e}}}{{{i}_{ds}^{e}}^{*}} \qquad Equation 5$$

$$σ {L}_{s} = \frac{{λ}_{qs}^{\hat{e}}}{{{i}_{qs}^{e}}^{*}} \qquad Equation 6$$

Here, Lᵣ represents rotor inductance, Lₘ represents magnetizing inductance, σ represents a leakage constant, and Lₛ represents stator inductance.

In addition, estimated rotor flux values may be used to estimate a rotor flux angle error through Equation 7 below.

$${\tilde{θ}}_{e} = a tan \frac{{λ}_{qr}^{\hat{e}}}{{λ}_{dr}^{\hat{e}}} \qquad Equation 7$$

Here, \tilde{θ}ₑ represents a rotor flux angle error.

When the rotor flux angle error is estimated, the extraction unit 140 may extract the parameters of the induction motor 10 based on the estimated rotor flux angle error. More specifically, the extraction unit 140 may extract a rotor time constant by using the equation below.

$${τ}_{r} = \frac{1}{{ω}_{sl}} \frac{{{i}_{ds}^{e}}^{*} sin {\tilde{θ}}_{e} + {{i}_{qs}^{e}}^{*} cos {\tilde{θ}}_{e}}{{{i}_{ds}^{e}}^{*} cos {\tilde{θ}}_{e} - {{i}_{qs}^{e}}^{*} sin {\tilde{θ}}_{e}} \qquad Equation 8$$

Here, τᵣ represents a rotor time constant, ωₛₗ represents slip angular velocity. The slip angular velocity may be estimated by using rotor inductance, rotor resistance, and current commands of the d-axis and q-axis of a synchronous coordinate system.

In addition, the correction unit 150 may correct current commands based on the estimated rotor flux angle error, and when the current commands are corrected, the drive unit 110 may drive the induction motor 10 by controlling the inverter 20 based on the corrected current commands. In this case, the correction of the current commands may be performed by using Equations 9 and 10 below.

$${{i}_{qs}^{e}}^{* ′} = {{i}_{ds}^{e}}^{* ′} sin {\tilde{θ}}_{e} + {{i}_{qs}^{e}}^{*} cos {\tilde{θ}}_{e} \qquad Equation 9$$

$${{i}_{ds}^{e}}^{* ′} = {{i}_{qs}^{e}}^{* ′} cos {\tilde{θ}}_{e} + {{i}_{ds}^{e}}^{*} sin {\tilde{θ}}_{e} \qquad Equation 10$$

As such, the correction of current commands may be repeated until the rotor flux angle error becomes less than or equal to a preset value, and in this case, the extraction unit 140 extracts the parameters when the rotor flux angle error becomes less than or equal to the preset value, and thus the accuracy of parameter extraction may be improved through the correction that reflects the rotor flux angle error.

Meanwhile, current commands may be determined based on a preset current command map, and in this case, the correction unit 150 may correct the current commands by correcting the current command map based on a rotor flux angle error. Here, the current command map may be one that is mapped so that current commands of the d-axis and q-axis of the synchronous coordinate system respectively correspond to a magnetic flux value and torque for each operating point.

In addition, the drive unit 110 may drive the induction motor 10 by controlling the inverter 20 based on the current commands corresponding to a plurality of operating points, and accordingly, the measurement unit 120 may measure torque and reactive power for each of the plurality of operating points, whereby stator flux values corresponding to the torque and reactive power, which are measured for each of the plurality of operating points, may be estimated.

Through this way, the parameters of the induction motor 10 may be extracted for each operating point, and accordingly, a range in which the extracted parameters are optimally operable may become expandable.

According to the exemplary embodiments, the extraction unit 140 may extract parameters corresponding to respective current commands included in the corrected current command map. In this case, the parameters may be extracted in the form of a table in which the parameters are matched to correspond to respective current values of the d-axis and q-axis of the synchronous coordinate system, and the respective parameter values may be expressed as, for example,

$${τ}_{r} ( {{i}_{ds}^{e}}^{*} , {{i}_{qs}^{e}}^{*} ) , {λ}_{dr} ( {{i}_{ds}^{e}}^{*} , {{i}_{qs}^{e}}^{*} ) , {L}_{s} ( {{i}_{ds}^{e}}^{*} , {{i}_{qs}^{e}}^{*} ) , σ {L}_{s} ( {{i}_{ds}^{e}}^{*} , {{i}_{qs}^{e}}^{*} ) ,$$

etc.

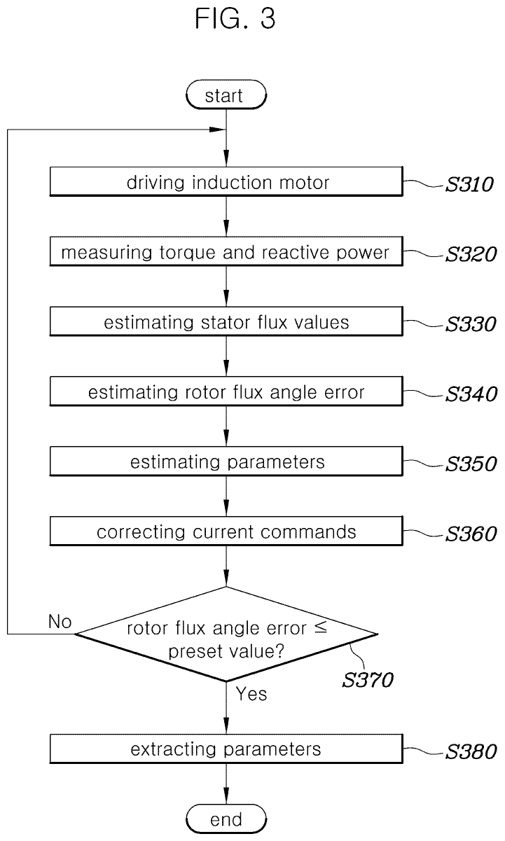

Hereinafter, with reference to FIG. 3, a method of extracting parameters of an induction motor according to an exemplary embodiment is described.

FIG. 3 is a flowchart for describing a process of extracting the parameters of the induction motor according to the exemplary embodiment of the present disclosure.

Referring to FIG. 3, first, in step S310, a drive unit 110 may initially drive an induction motor 10 based on initial parameters obtained from a constraint condition, a no-load condition, etc.

A measurement unit 120 may measure torque of the induction motor 10 and reactive power of an inverter 20 according to the initial driving in step S320. An estimation unit 130 may estimate stator flux values from the measured torque and reactive power in step S330, and estimate, in step S340, a rotor flux angle error through the estimated stator flux values.

In this case, the parameters of the induction motor 10 are estimated by reflecting the rotor flux angle error in step S350, and current commands may be corrected by reflecting the rotor flux angle error in step S360.

These processes S310 through S360 are repeated until the rotor flux angle error becomes less than or equal to a preset value (i.e., “No” of S370), and during these processes, the estimated values of the respective parameters change.

Thereafter, when the rotor flux angle error becomes less than or equal to the preset value through the repeated execution (i.e., “Yes” in S370), an extraction unit 140 may extract the estimated parameters as final values in step S380.

According to various exemplary embodiments of the present disclosure as described above, the accuracy of parameters extraction of the induction motor may be improved by utilizing the estimated magnetic flux values based on the measured values of torque and reactive power.

As described above, although preferred embodiments of the present disclosure have been described for illustrative purposes, those skilled in the art will appreciate that various modifications, additions, and substitutions are possible, without departing from the technical scope and spirit of the present disclosure as provided in the accompanying claims.

1. A method of extracting parameters of an induction motor, the method comprising:
driving, by a drive unit, the induction motor by controlling an inverter based on current commands;
measuring, by a measurement unit, a torque of the induction motor and reactive power of the inverter according to the driving of the induction motor;
estimating, by an estimation unit, stator flux values of the induction motor based on the measured torque and reactive power; and
extracting, by an extraction unit, the parameters of the induction motor based on the stator flux values;
wherein the driving of the induction motor includes driving the induction motor by controlling the inverter further considering the extracted parameters of the induction motor.

2. The method of claim 1, wherein the parameters of the induction motor include at least one of a rotor time constant, rotor flux values, stator inductance, and a leakage constant.

3. The method of claim 1, further including:
estimating a rotor flux angle error of the induction motor based on the estimated stator flux values,
wherein the extracting of the parameters of the induction motor includes extracting the parameters of the induction motor based on the estimated rotor flux angle error.

4. The method of claim 3, further including:
correcting the current commands based on the estimated rotor flux angle error,
wherein the driving of the induction motor includes driving the induction motor by controlling the inverter based on the corrected current commands.

5. The method of claim 4, wherein the correcting of the current commands includes repeating the correction of the current commands until the rotor flux angle error becomes a value less than or equal to a preset value, and
the extracting of the parameters includes extracting the parameters when the rotor flux angle error becomes the value less than or equal to the preset value.

6. The method of claim 4, wherein the driving of the induction motor includes driving the induction motor by controlling the inverter based on the respective current commands corresponding to a plurality of operating points;
the measuring of the torque of the induction motor and the reactive power of the inverter includes measuring the torque and the reactive power for each of the plurality of operating points; and
the estimating of the stator flux values of the induction motor includes estimating the stator flux values corresponding to the torque and the reactive power, which are measured for each of the plurality of operating points.

7. The method of claim 6, wherein the respective current commands corresponding to the plurality of operating points are determined based on a preset current command map; and
the correcting of the current commands includes correcting the current command map based on the rotor flux angle error.

8. The method of claim 7, wherein the extracting of the parameters includes extracting the parameters corresponding to the respective current commands included in the corrected current command map.

9. The method of claim 1, wherein the driving of the induction motor includes initially driving the induction motor by controlling the inverter based on initial parameters of the induction motor, the initial parameters being obtained under preset driving conditions including a constraint condition and a no-load condition; and
the measuring of the torque of the induction motor and the reactive power of the inverter includes measuring the torque of the induction motor and the reactive power of the inverter according to the initial driving of the induction motor.

10. An apparatus of extracting parameters of an induction motor, the apparatus including:
a drive unit configured to drive the induction motor by controlling an inverter based on current commands;
a measurement unit configured to measure torque of the induction motor and reactive power of the inverter according to the driving of the induction motor;
an estimation unit configured to estimate stator flux values of the induction motor based on the measured torque and reactive power; and
an extraction unit configured to extract the parameters of the induction motor based on the stator flux values;
wherein the drive unit is configured to drive the induction motor by controlling the inverter further considering the extracted parameters of the induction motor.

11. The apparatus of claim 10, wherein the parameters of the induction motor include at least one of a rotor time constant, rotor flux values, stator inductance, and a leakage constant.

12. The apparatus of claim 10, wherein the estimation unit is configured to estimate a rotor flux angle error of the induction motor based on the estimated stator flux values, and
the extraction unit is configured to extract the parameters of the induction motor based on the estimated rotor flux angle error.

13. The apparatus of claim 12, further including:
a correction unit configured to correct the current commands based on the estimated rotor flux angle error,
wherein the drive unit drives the induction motor by controlling the inverter based on the corrected current commands.

14. The apparatus of claim 13, wherein the correction unit is configured to repeat the correction of the current commands until the rotor flux angle error becomes a value less than or equal to a preset value, and
the extraction unit is configured to extract the parameters when the rotor flux angle error becomes the value less than or equal to the preset value.

15. The apparatus of claim 14, wherein the drive unit drives the induction motor by controlling the inverter based on the respective current commands corresponding to a plurality of operating points;
the measurement unit is configured to measure the torque and the reactive power for each of the plurality of operating points; and
the estimation unit is configured to estimate the stator flux values corresponding to the torque and the reactive power, which are measured for each of the plurality of operating points.

16. The apparatus of claim 15, wherein the respective current commands corresponding to the plurality of operating points are determined based on a preset current command map, and
the correction unit is configured to correct the current command map based on the rotor flux angle error.

17. The apparatus of claim 16, wherein the extraction unit is configured to extract the parameters corresponding to the respective current commands included in the corrected current command map.

18. The apparatus of claim 10, wherein the drive unit initially drives the induction motor by controlling the inverter based on initial parameters of the induction motor, the initial parameters being obtained under preset driving conditions including a constraint condition and a no-load condition, and
the measurement unit measures the torque of the induction motor and the reactive power of the inverter according to the initial driving of the induction motor.
